(19) United States
(12) Patent Application Publication
(10) Pub. No.: US 2023/0098452 A1
(43) Pub. Date: Mar. 30, 2023

(54) FINGERPRINT RECOGNITION SENSOR STRUCTURE CAPABLE OF BIOMETRIC AUTHENTICATION AND ELECTRONIC CARD USING THE SAME

(71) Applicant: REAL IDENTITY CO., LTD., Seoul (KR)

(72) Inventors: Seong Su PARK, Yongin-si (KR); Sung Hoon JUNG, Paju-si (KR); Ssum Gyu LEE, Seoul (KR)

(73) Assignee: REAL IDENTITY CO., LTD., Seoul (KR)

(21) Appl. No.: 17/745,729

(22) Filed: May 16, 2022

(30) Foreign Application Priority Data
Sep. 28, 2021 (KR) 10-2021-0128320

(51) Int. Cl. G06F 21/45; G06F 21/32; G06V 40/13; G06K 19/07

(52) U.S. Cl. CPC G06F 21/45; G06F 21/32; G06V 40/13; G06K 19/0718

(57) ABSTRACT

The present invention relates to a biometric and fingerprint recognition sensor structure and an electronic card using the same. The present invention discloses a biometric and fingerprint recognition sensor structure comprising: a fingerprint sensing electrode array comprising a plurality of fingerprint sensing electrodes and a biometric authentication electrodes formed to be electrically spaced apart along the outer edge of the fingerprint sensing electrode array. Conventionally, the electrode for biometric authentication has to be formed through a separate process from the fingerprint sensing electrode, but the biometric and fingerprint recognition sensor structure and the electronic card using the same according to the present invention can be formed through the same process as the fingerprint sensing electrode according to an appropriate design.

### CROSS-REFERENCE TO RELATED APPLICATIONS

This application claims the benefit of Korean Application No. 10-2021-0128320, filed Sep. 28, 2021, in the Korean Intellectual Property Office. All disclosures of the document named above are incorporated herein by reference.

### BACKGROUND OF THE INVENTION

### Field of the Invention

The present invention relates to a biometric and fingerprint recognition sensor structure capable of biometric authentication and an electronic card using the same, and more particularly, to a biometric and fingerprint recognition sensor structure having an insulator on an upper portion of a biometric authentication electrode, and an electronic card using the same.

### Description of the Related Art

Credit cards are used to solve the inconvenience of carrying large amounts of cash. When registering a credit card, a password is assigned so that only the person can use it, and the credit card is signed and used. You can easily carry a credit card with you, but when you need cash, you can withdraw cash by inserting your credit card into an ATM and entering your password. Even if you use a credit card to pay online, you need to enter a password, so you can proceed with the payment relatively safely. Contrary to this, when purchasing an item offline, insert it into the card slot of the terminal installed in the store and write your signature to complete the payment.

Credit cards have the advantage of being easy to use, but losing them can cause a lot of loss. If the credit card is lost and the loss is not reported, the person who acquires it can use the lost credit card of another person to purchase goods at an offline store and pay for public transportation, so the original credit card owner suffers a lot of financial loss. If the password is lost or stolen while exposed, it is possible to withdraw cash as well, resulting in greater financial loss.

Due to such a problem, an attempt has been made to mount a fingerprint sensor on a credit card in order to increase the security of the credit card. The fingerprint sensor can be classified into a capacitive fingerprint sensor, an ultrasonic fingerprint sensor, and an optical fingerprint sensor according to a driving method. Among them, considering the thickness that can be implemented in a credit card, a method suitable for applying to a credit card can be called a capacitive fingerprint sensor. On the other hand, the fingerprint sensor has a problem in that authentication is easily passed by a counterfeit fingerprint made of silicon, etc., so a technology to compensate for this is needed.

### SUMMARY OF THE INVENTION

An object of the present invention is to provide a biometric and fingerprint recognition sensor structure capable of rejecting authentication when authentication is attempted using a forged fingerprint, and an electronic card using the same.

The present invention is to solve the above problems, and an object of the present invention is to provide A biometric and fingerprint recognition sensor structure comprising: a fingerprint sensing electrode array comprising a plurality of fingerprint sensing electrodes and a biometric authentication electrodes formed to be electrically spaced apart along the outer edge of the fingerprint sensing electrode array; wherein the biometric authentication electrodes are composed of a first electrode for biometric authentication and a second electrode for biometric authentication formed at a distance of D2 from each other, and wherein a material having a surface resistivity (Ω/cm2) of 1012 to 1013 is formed on the upper portion of the biometric authentication electrode to a height of D1.

Conventionally, the electrode for biometric authentication has to be formed through a separate process from the fingerprint sensing electrode, but the biometric and fingerprint recognition sensor structure and the electronic card using the same according to the present invention can be formed through the same process as the fingerprint sensing electrode according to an appropriate design.

### BRIEF DESCRIPTION OF THE DRAWINGS

The objects, features and advantages of the present invention will be more apparent from the following detailed description in conjunction with the accompanying drawings, in which:

FIG. 1 is a block diagram of an electronic card according to an embodiment of the present invention.

FIG. 2A is a plan view of a biometric fingerprint sensor installed on an electronic card in a state in which lamination of a cover film is completed, and FIG. 2B is a cross-sectional view in the A-A′ direction of FIG. 2A.

FIG. 3A is a plan view of a biometric fingerprint recognition sensor installed on an electronic card in a state in which lamination of a cover film is completed, and FIG. 3B is a sectional view in the direction B-B′ of FIG. 3A.

FIG. 4 is an equivalent circuit diagram of a device related to biometric authentication in the biometric and fingerprint recognition sensor according to the present invention.

FIG. 5A is a square wave is applied to the driving unit of the biometric and fingerprint recognition sensors shown in FIGS. 2A and 3B.

FIG. 5B is a voltage waveform diagram that is sensed and output by the biometric and fingerprint recognition sensors shown in FIGS. 2A and 3B.

FIGS. 6A to 6D are conceptual diagram illustrating a processes in which electric charges are polarized in a biometric fingerprint when a voltage is applied to a first electrode for biometric authentication.

FIG. 7 is a graph showing experimental results of a state in which there is no object to be touched between biometric authentication electrodes and a state in which a biometric fingerprint is touched.

FIG. 8 is a graph showing experimental results of a state in which a thick conductive rubber is placed between biometric authentication electrodes and a state in which a biometric fingerprint is touched.

FIG. 9 is a graph showing experimental results of a state in which a thin conductive rubber is placed between biometric authentication electrodes and a state in which a biometric fingerprint is touched.

FIG. 10 is a graph showing experimental results of a state in which a fake fingerprint made of wet clay is placed between biometric authentication electrodes and a state in which the biometric fingerprint is touched.

FIG. 11 is a graph showing experimental results of a state in which a fake fingerprint made of dry clay is placed between biometric authentication electrodes and a state in which the biometric fingerprint is touched.

FIG. 12 is a graph showing experimental results of a state in which a fake fingerprint made of silicon is placed between the biometric authentication electrodes and a state in which the biometric fingerprint is touched.

FIG. 13A is a plan view of a biometric fingerprint sensor in which an electrode for biometric recognition is formed in a ring shape in the biometric fingerprint sensor, and FIG. 13B is a cross-sectional view in the C-C′ direction of FIG. 13A.

### DETAILED DESCRIPTION OF EXEMPLARY EMBODIMENTS

An electronic card in the present invention means a card having a thin thickness including an integrated circuit (IC) chip therein. Conventionally, a card in which information required for payment by a credit card is stored in a magnetic strip has been widely used. Since these magnetic strips are easily copied and thus vulnerable to security, credit cards provided with magnetic strips are being replaced by electronic cards including IC chips.

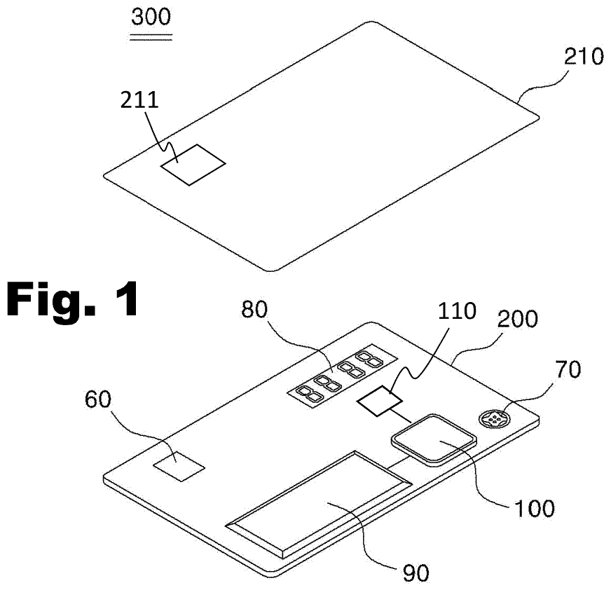

FIG. 1 is a block diagram of an electronic card according to an embodiment of the present invention. The electronic card 300 according to the present invention includes an IC chip 60, a display unit 80, an input button 70, a battery 90, a biometric and fingerprint authentication chip 110 and a biometric device on a base substrate 200. And the fingerprint recognition sensor 100 is provided and has a laminated structure on which the cover film 210 is laminated. In the electronic card shown in FIG. 1, the display unit 80, the battery 90, and the input button 70 are not necessarily provided.

The base substrate 200 has a structure in which a printed circuit board is laminated on a main base film. The main base film can be implemented using a hard-setting resin. In FIG. 1, the main base film and the printed circuit board are shown as one substrate without separate distinction. The IC chip 60 is a semiconductor chip having a small capacity memory for storing important information of the card holder. In general, an IC chip is composed of a gold-colored contact terminal that can be visually confirmed and a semiconductor chip provided under the contact terminal. The display unit 80 is a display device that displays whether or not fingerprint authentication is performed, and may be implemented as an organic EL display having a thin thickness or an electrically linked display. The input button 70 is a switch for receiving a user input for turning on/off power or selecting an operation mode, and may be implemented as a toggle button or a dome switch. The battery 90 is a module for applying power to each circuit element, and may be implemented as a rechargeable battery capable of charging and discharging, a thin mercury battery, or a solar cell. When an antenna is provided and each circuit element is operated by receiving wireless energy using induced electromotive force through the antenna, the battery 90 may be omitted. The biometric and fingerprint recognition sensor 100 is a sensor for detecting a user's fingerprint and biometric status, and in the present invention, a capacitive fingerprint sensor is used as a fingerprint authentication sensor. The biometric and fingerprint authentication chip 110 is a chip that uses the output value sensed by the biometric and fingerprint recognition sensor 100 to authenticate whether it is a biometric or whether a fingerprint matches.

The cover film 210 is a film for protecting the circuit element mounted on the base substrate 200, and is laminated on the base substrate 200 and the circuit element by lamination. Of course, a window 211 for exposing the contact terminal of the IC chip to the outside may be formed on the cover film 210.

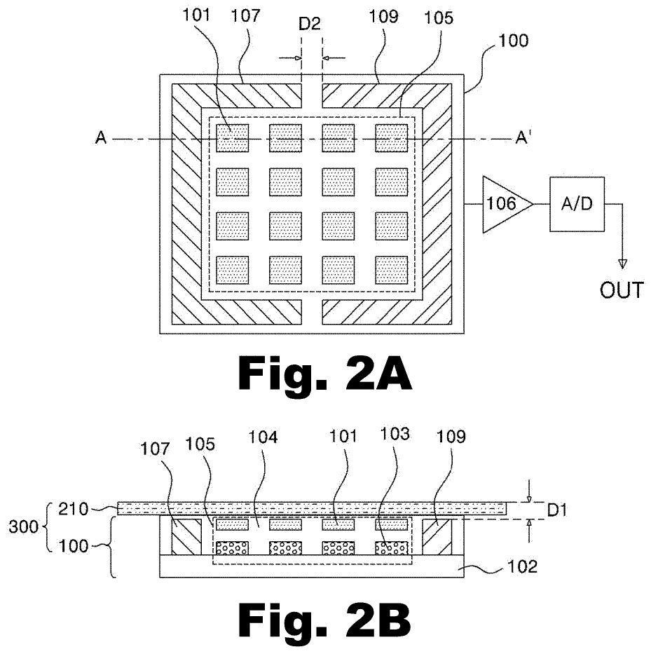

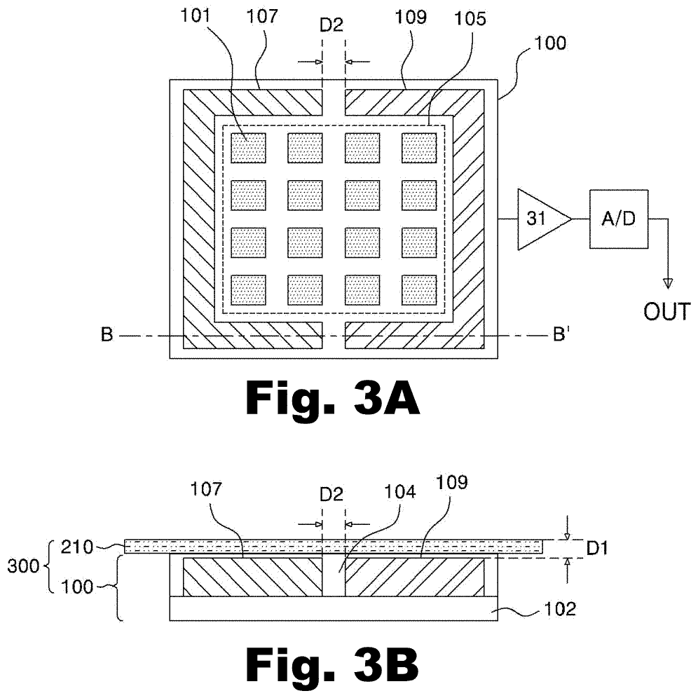

FIG. 2A is a plan view of a biometric fingerprint recognition sensor installed on an electronic card in a state where the cover film lamination is completed, and FIG. 2B is a cross-sectional view in the A-A′ direction in the plan view. FIG. 3A shows a plan view of a biometric fingerprint recognition sensor installed on an electronic card in a state where the cover film lamination is completed, and FIG. 3B is a sectional view in the direction B-B′ in the plan view. As shown in FIGS. 2A to 3B, the biometric and fingerprint recognition sensor 100 includes a capacitive fingerprint sensing electrode 101 for detecting a fingerprint and electrodes 107 and 109 for biometric authentication. The plurality of fingerprint sensing electrodes 101 are arranged in an array form to form the fingerprint sensing electrode array 105. The biometric authentication electrodes 107 and 109 are composed of a first biometric authentication electrode 107 and a biometric authentication second electrode 109 disposed along the periphery of the fingerprint sensing electrode array 105. As shown in the cross-sectional view of FIG. 2B, the fingerprint sensing electrode array 105 has a structure in which the fingerprint sensing electrode 101 and the fingerprint sensing circuit electrode 103 are installed in pairs. The shape and arrangement of the electrodes of the fingerprint sensing electrode array 105 may be applied to any of the various techniques known through a sensor for detecting a fingerprint in the prior art.

The applicant of the present invention has proposed and registered a technology for authenticating whether or not a living body using two electrodes (a first electrode for biometric authentication, a second electrode for biometric authentication) that are in contact with a living body (Korean Patent Registration No. 10-1972318). However, in Korean Patent Registration No. 10-1972318, there was a restriction that two electrodes for biometric authentication should be formed so as to be exposed so as to be in direct contact with the living body. In order to form the electrode for biometric authentication in this exposed form, unlike the process of forming the electrode for the fingerprint sensor, the biometric electrode must be implemented using a separate process, so manufacturing a fingerprint recognition sensor capable of biometric authentication is expensive.

In order to solve the problem of increasing manufacturing cost, the present invention is formed such that the biometric authentication electrodes 107 and 109 are also formed to be recessed in the mold 104 similarly to the fingerprint sensing electrode 101, as shown in FIG. 2B. An object of the present invention is to propose a fingerprint recognition sensor structure capable of biometric authentication.

The biometric and fingerprint recognition sensor 100 capable of biometric authentication according to the present invention includes a fingerprint sensor array 105 formed on a semiconductor wafer 102, a first electrode 107 for biometric authentication, and a second electrode 109 for biometric authentication. The fingerprint sensor array 105, the first electrode 107 for biometric authentication, and the second electrode 109 for biometric authentication are configured to be covered by the mold 104 up to the top. The first electrode 107 for biometric authentication and the second electrode 109 for biometric authentication are respectively formed along the outer periphery of the fingerprint sensor array 105 and are arranged to maintain a minimum separation distance of ‘D2’ from each other. Here, the minimum separation distance means a distance on the closest measured position among the separation distances between the first electrode 107 for biometric authentication and the second electrode 109 for biometric authentication. The biometric and fingerprint recognition sensor 100 includes an amplifier 106 for amplifying an electrical signal sensed by each electrode and an A/D converter. A cover film 210 is formed in a laminated manner on the biometric and fingerprint recognition sensor 100 and the mold 104 constituting the same to form the biometric and fingerprint recognition sensor structure 300.

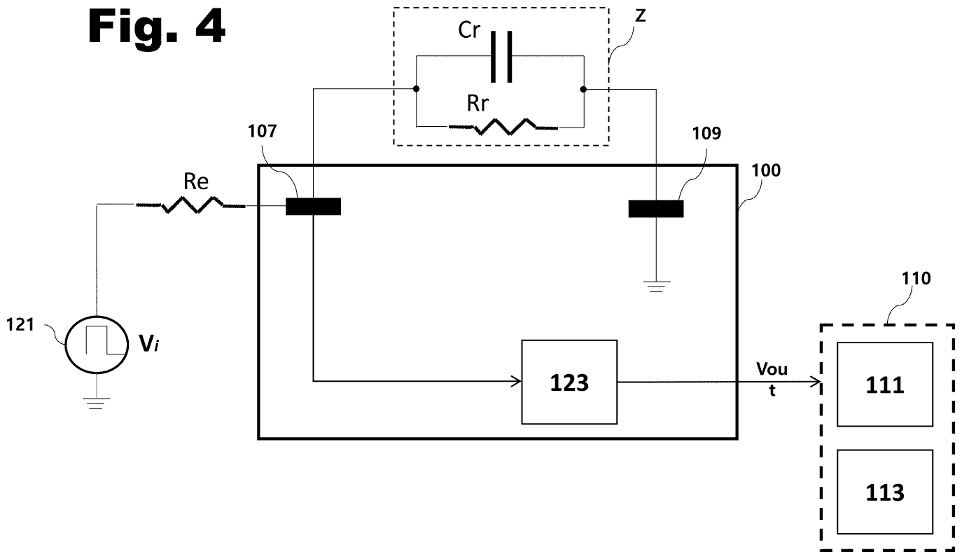

A method of performing biometric authentication using the biometric authentication electrodes 107 and 109 in the biometric and fingerprint recognition sensor 100 according to the present invention will be briefly described. FIG. 4 is an equivalent circuit diagram of a device related to biometric authentication in the biometric and fingerprint recognition sensor according to the present invention. The reference symbol ‘Z’ indicates the equivalent circuit of a living body. In the equivalent circuit of the device related to biometric authentication, the second electrode 109 for biometric authentication is connected to the ground, and one end of the first electrode 107 for biometric authentication is connected to the ground through the resistor Re and the driving unit 121 and the first electrode 107 for biometric authentication is also connected to the sensing unit 123. The sensing unit 123 is composed of an amplifier and a D/A converter, and outputs a voltage value sensed by the first electrode 107 for biometric authentication as a digital value. The biometric and fingerprint authentication chip 110 performs biometric authentication using the output voltage value.

An operation principle of performing biometric authentication will be briefly described with reference to FIG. 4. In a state where the first electrode 107 for biometric authentication and the second electrode 109 for biometric authentication are positioned close to the biometric Z, the driving unit 121 applies a square wave having a single cycle to the first electrode 107 for biometric authentication, in a state in which the voltage measured by the first electrode 107 for biometric authentication is stabilized, the voltage value sensed by the first electrode 107 for biometric authentication is output to the biometric and fingerprint authentication chip 110. The biometric and fingerprint authentication chip 110 includes a signal processing unit 111 and a control unit 113, wherein the signal processing unit 111 is the highest measured voltage value, which is the highest value of the sensed voltage value from the sensed voltage value, and the lowest value of the sensed voltage. The measured voltage width (Vw) obtained by detecting the lowest measured voltage value, the difference between the highest measured voltage and the lowest measured voltage, and the time it takes for the detected voltage to reach a specific range from the lowest measured voltage to the highest measured voltage (Tm) signal processing. The control unit 113 applies an operation control signal necessary to the driving unit 121, the sensing unit 123 and the signal processing unit 111. The biometric and fingerprint authentication chip 110 uses the measured voltage width (Vw) and the required time (Tm) detected by the biosignal processing unit 111 to authenticate whether the biometric is present.

In FIG. 4, the biometric and fingerprint recognition sensor 100 is shown to be provided with a biometric authentication first electrode 107, a biometric authentication second electrode 109, and a sensing unit 123. But the resistance Re and the driving unit Vi can also be implemented as a component included in the biometric and fingerprint recognition sensor 100. In addition, although the biometric and fingerprint authentication chip 110 is illustrated as being composed of only the signal processing unit 111 and the control unit 113, a small-sized memory is of course included and may be implemented to include various components for authenticating the biometric.

However, as shown in FIGS. 2 and 3, when manufacturing the biometric and fingerprint recognition sensor 100, the biometric authentication electrodes 107 and 109 are manufactured using the same manufacturing process as the fingerprint sensing electrode 101. The electrodes 107 and 109 are formed to be recessed in the mold 104. In addition, in order to manufacture the electronic card, since the cover film 210 is laminated on the mold 104, the biometric authentication electrodes 107 and 109 cannot directly come into contact with the living body through the mold 9104 and the cover film 210. It has to be contacted.

According to the inventor's experiment, when the mold 104 and the cover film 210 are formed of a material having a surface resistivity (Ω/cm2) of 1012 to 1013, charge polarization occurs only for a short time after being charged with the living body, and this short time It was found that biometric authentication can be performed by measuring the charge polarization phenomenon occurring in the biometric authentication electrodes 107 and 109.

5 is a voltage waveform diagram that is sensed and output by the biometric and fingerprint recognition sensors shown in FIGS. 2 and 3 when a square wave is applied to the driving unit.

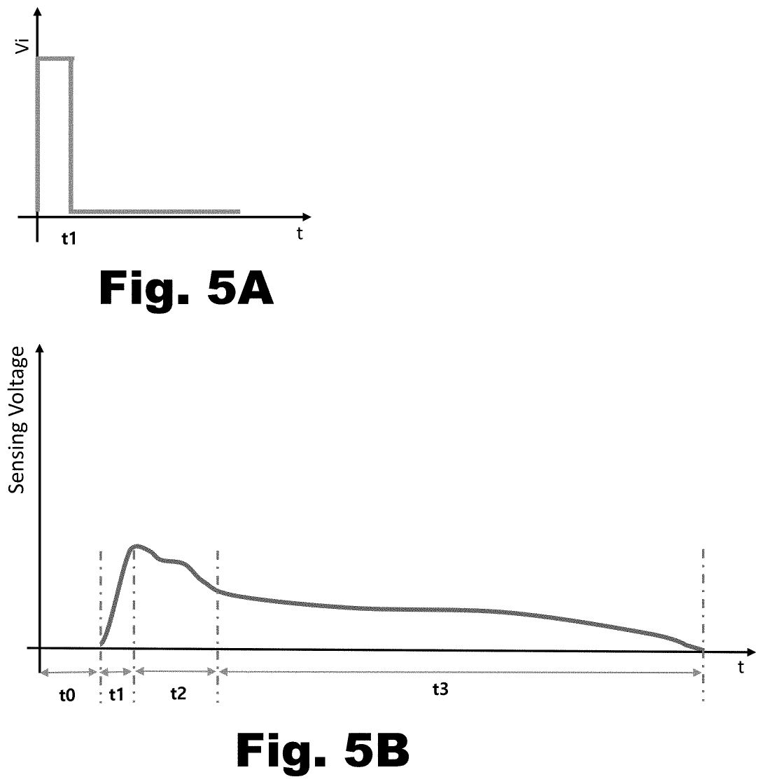

As shown in FIG. 5A, when a square wave having a voltage that is instantaneously changed through the driving unit and having a t1 duration is applied, the sensing voltage as shown in FIG. 5B is output to the biometric and fingerprint recognition sensor 100.

The section t0 indicates a delay time at which electrical polarization starts. The charging section (t1) is a section in which a voltage charged to the mold and the cover film is generated by the human voltage of the driving section, and the rapid decay section (t2) is a section in which the charged charges are attenuated in a relatively short time, and a gentle attenuation section (t3) means a period in which the remaining charge gradually decays for a relatively long time after charging.

According to the inventor's experiment, when the mold 104 and the cover film 210 are formed of a material having a surface resistivity (Ω/cm2) of 1012 to 1013, charge polarization occurs only for a short time after being charged with the living body. It has been found that biometric authentication can be performed by measuring the charge polarization phenomenon occurring in such a short time through the biometric authentication electrodes 107 and 109. FIG. 5A is a voltage waveform diagram that is sensed and output by the biometric and fingerprint recognition sensors shown in FIGS. 2 and 3 when a square wave is applied to the driving unit. As shown in FIG. 5A, when a square wave having a voltage that is instantaneously changed through the driving unit and having a t1 duration is applied, the sensing voltage as shown in FIG. 5B is output to the biometric and fingerprint recognition sensor 100. The section t0 indicates a delay time at which electrical polarization starts. The charging section (t1) is a section in which a voltage charged to the mold and the cover film is generated by the human voltage of the driving section, and the rapid decay section (t2) is a section in which the charged charges are attenuated in a relatively short time, and a gentle attenuation section (t3) means a period in which the remaining charge gradually decays for a relatively long time after charging.

In the present invention, when the mold 104 and the cover film 210 are formed of a material having a surface resistivity (Ω/cm²) of 10¹² to 10¹³, it was found that by comparing the characteristics of the attenuation of charged charges in the rapid decay period (t2), it was possible to determine whether a living body was present. When the mold 104 and the cover film 210 are formed with a material having a surface intrinsic resistance (Ω/cm2) of 10¹² to 10¹³, the resistance (Re) is good to be 150 KΩ to 500 KΩ in order to maintain the sensitivity for determining whether the body is living or not.

When the mold 104 and the cover film 210 are made of a material having a surface resistivity (Ω/cm²) exceeding 10¹³, since they have non-conductive properties, no charging phenomenon occurs, and thus the living body cannot be authenticated. In addition, when the mold 104 and the cover film 210 are made of a material having a surface resistivity (Ω/cm2) less than 10¹², it shows a characteristic close to a conductor, so the charging phenomenon occurs in a too short period of time, so biometric authentication is checked It was difficult to do.

For the cover film having a surface resistivity (Ω/cm²) of 10¹² to 10¹³, any one selected or a mixture of two or more selected from an epoxy film, a polyester film, a polyimide film, a vinyl series, or the like may be used.

According to the inventor of the present invention, in order to configure biometric authentication in the biometric and fingerprint recognition sensor structure formed is recessed in the mold, in addition to the surface resistivity (Ω/cm²) of the material forming the mold 104 and the cover film 210, the minimum separation distance D2 between the biometric authentication electrodes and the thickness D1 of the mold 104 and the cover film 210 stacked on the biometric authentication electrode should have the same characteristics as in Equation 1, when the minimum separation distance (D2) is less than 300 μm. Even if the relationship satisfies Equation 1, when the minimum separation distance D2 exceeds 300 μm, the measured capacitance is too small, and the measurement accuracy is lower than 90%, making it difficult to use. Therefore, the maximum value of the minimum separation distance D2 is 300 μm.

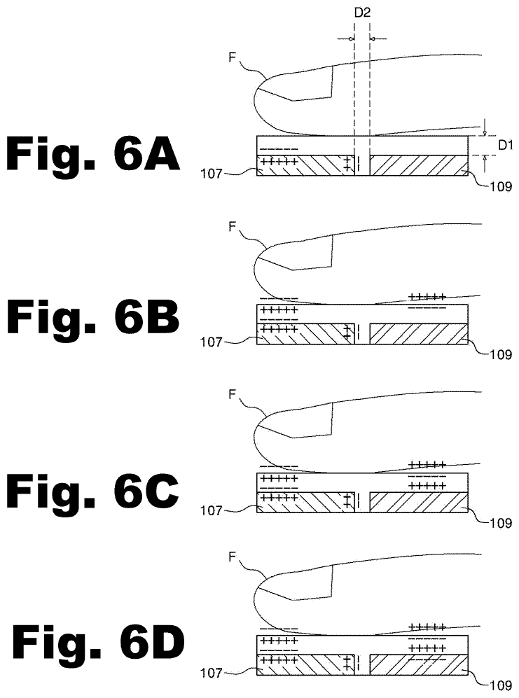

According to Equation 1, D2 should be formed to be larger than twice and smaller than three times D1. When the minimum separation distance (D2) was smaller than twice that of D1, it was found that charging did not occur to the living body and that charging appeared and disappeared only between the cover film and the mold (the dielectric polarization phenomenon as shown in FIG. 6 to be described later did not appear in the living body.). It is expected that this is because the charge generated from the+electrode flows to the ground without polarization to the living body. When the minimum separation distance D2 is greater than three times D1, it is difficult to measure the charge generated between the biometric authentication first electrode 107 and the biometric authentication second electrode 109.

2×D1<D2<3×D1 Equation 1

In Equation 1, D1 represents the distance between the biometrics from the top surface of the biometrics electrode (measured while placing the biometrics on the biometrics electrodes for biometric authentication), and D2 is the biometrics first electrode and biometrics second electrode. It represents the minimum separation distance between them. After all, D1 represents the total thickness of the mold 104 and the cover film placed on the upper surface of the biometric authentication electrode. In Equation 1, since D2 cannot exceed 300 μm, the maximum value of D1 is calculated to be 150 μm. Since D1 is the thickness of the mold and cover film accumulated on the upper surface of the bio electrode, it is difficult to form less than 20 μm with current technology. Therefore, in Equation 1, D1 satisfies the range of 20 μm or more and 150 μm or less.

FIG. 6 is a conceptual diagram illustrating a process in which electric charges are polarized in a biometric fingerprint when a voltage is applied to the first electrode for biometric authentication. As shown in FIG. 6A to 6D, charges and electrons are generated by the charge supplied to the first electrode 107 for biometric authentication (FIG. 6A), and the generated charges and electrons are located on the upper finger F Induces charges and electrons with opposite polarities, and the induced charges induce charges of opposite polarity to the finger positioned above the battery electrode 109 (induced FIGS. 6C and 6D). As described above, when the minimum separation distance (D2) is smaller than twice that of D1, the charging does not occur even to the living body and the charging appears and disappears only between the cover film and the mold.

In a state where the biometric electrode laminates with a width of 1.2 mm, the minimum separation distance (D2) of 0.15 mm, a mold with a surface resistivity (Ω/cm2) of 1.1*1013, 0.02 mm, on the upper surface of the biometric authentication electrode, and polyvinyl chloride with a surface resistivity (Ω/cm²) of 1.1*10¹² was formed on the upper part of the mold to a thickness of 0.05 mm (D1 is 0.07 mm), fake fingerprints made of conductive rubber having the first and second thicknesses, fake fingerprints made of clay in a wet and dry state, fake fingerprints made of silicon, and biometric fingerprints were tested. The driving signal was applied to the biometric first electrode in increments of 5 Hz between 30 Hz and 75 Hz, and the time Tm required to reach 63.2% of the measured voltage width Vw from the lowest measured voltage was measured. After measuring a total of 1,000 times for each counterfeit fingerprint, sampling 10 each, and extracting the average value, the frequency and time required Tm were indicated with 100 pointers.

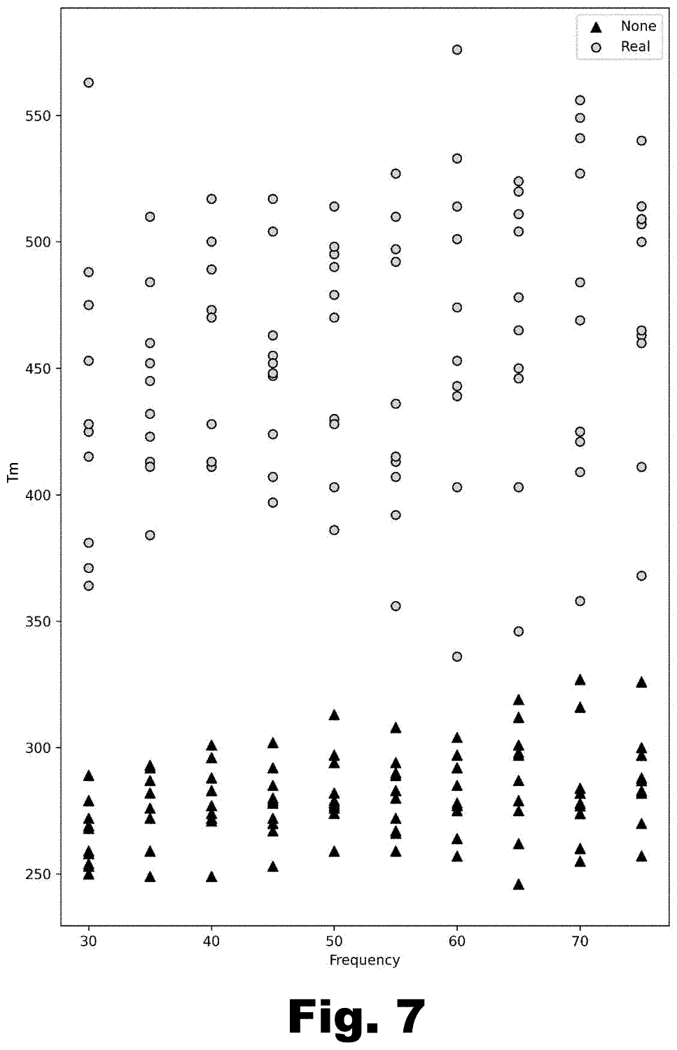

FIG. 7 is a graph showing experimental results of a state in which there is no object to be touched between the biometric authentication electrodes and a state in which a biometric fingerprint is touched. As shown in FIG. 7, it can be seen that the required time Tm is clearly differentiated between the no-touch (triangle dot) and the biometric fingerprint touch (circular dot). Specifically, in the case of a biometric fingerprint, the required time Tm has a value in the range of 350 to 550, whereas the non-touch has a value of 320 or less, so it can be seen that both are clearly distinguished in the entire frequency range. Both were able to grasp the greatest discriminatory power when the frequencies were 40 Hz and 45 Hz.

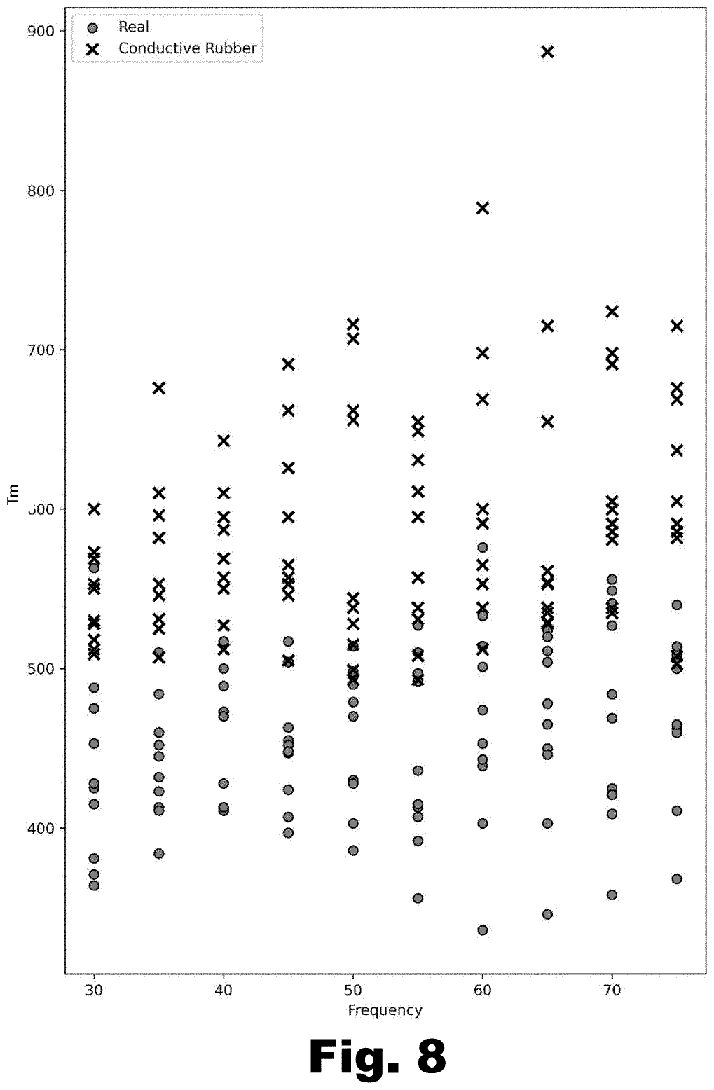

FIG. 8 is a graph showing experimental results of a state in which a thick conductive rubber is placed between biometric authentication electrodes and a state in which a biometric fingerprint is touched. As shown in FIG. 8, in the case of a counterfeit fingerprint (x-marked point) made of thick conductive rubber, the required time Tm does not have a value of 450 or less, whereas in the case of a biometric fingerprint (circular dot), a value of 450 or less is set at all frequencies. Since it has a range, it can be seen that the two can be distinguished.

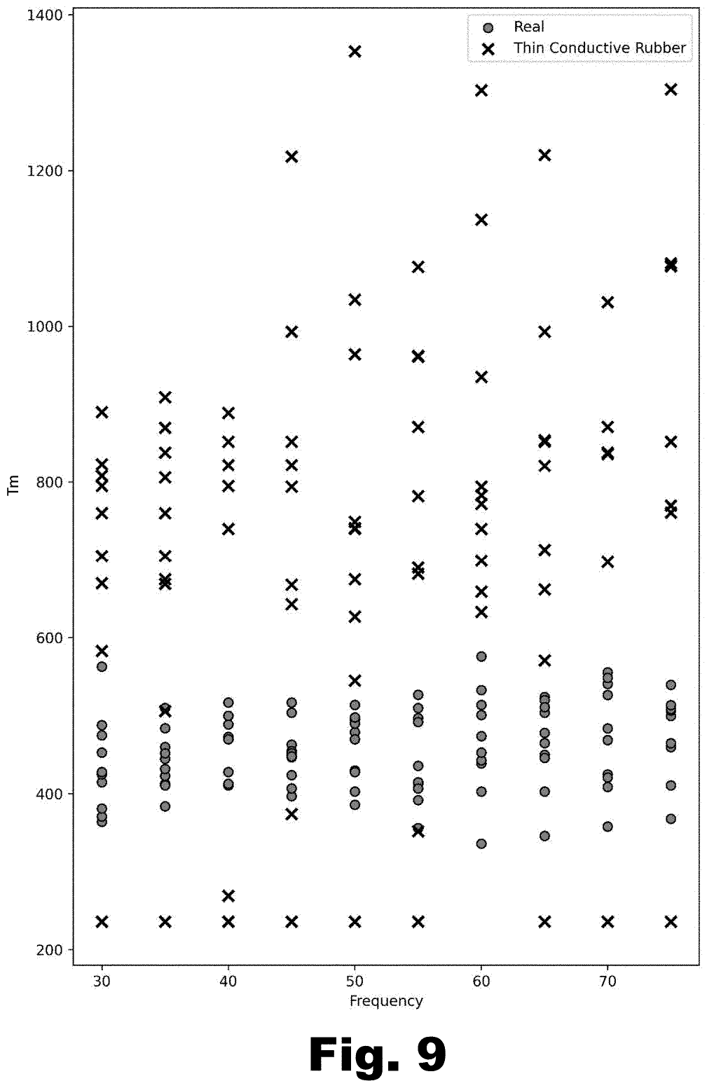

FIG. 9 is a graph showing experimental results of a state in which a thin conductive rubber is placed between biometric authentication electrodes and a state in which a biometric fingerprint is touched. As shown in FIG. 9, in the case of a counterfeit fingerprint (x-marked point) made of thin conductive rubber, the required time Tm was about 220 or values out of the prediction were measured as 1,000 or more, but in the case of a biometric fingerprint (circular dot) It can be seen that is in a stable range between 360 and 560.

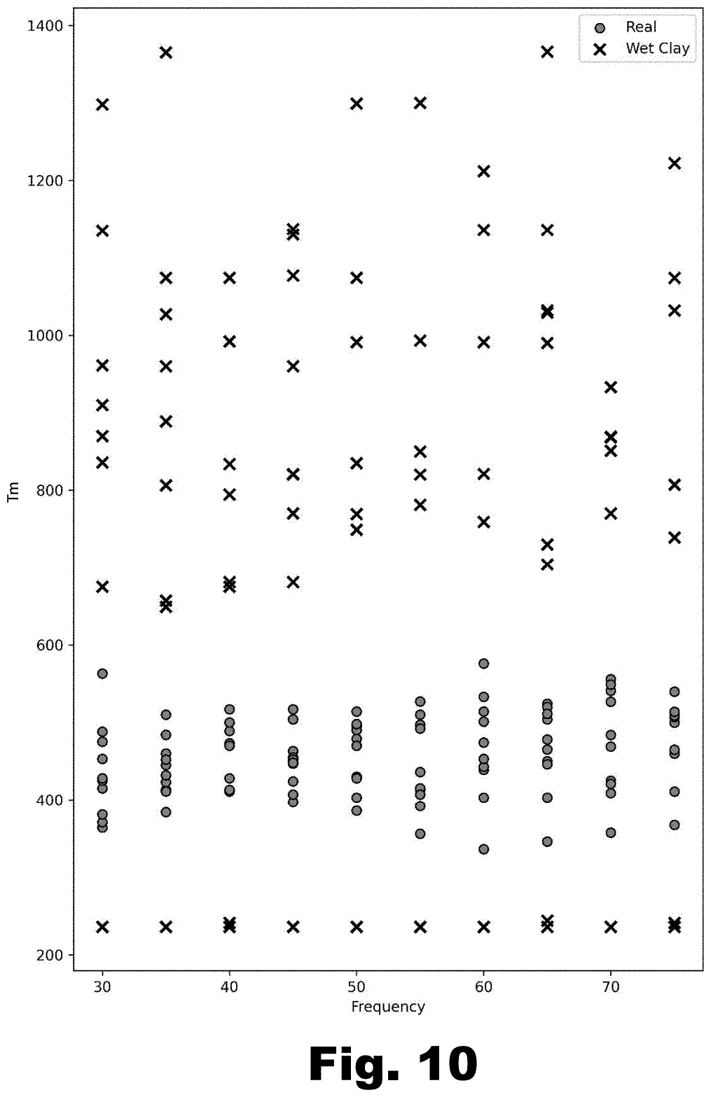

FIG. 10 is a graph showing experimental results of a state in which a fake fingerprint made of wet clay is placed between biometric authentication electrodes and a state in which the biometric fingerprint is touched. As shown in FIG. 10, it can be seen that both of them show clearly distinct characteristics of the required time Tm. In the case of counterfeit fingerprints (x-marked dots) made of wet clay, it often occurred that the time required Tm was measured around 220.

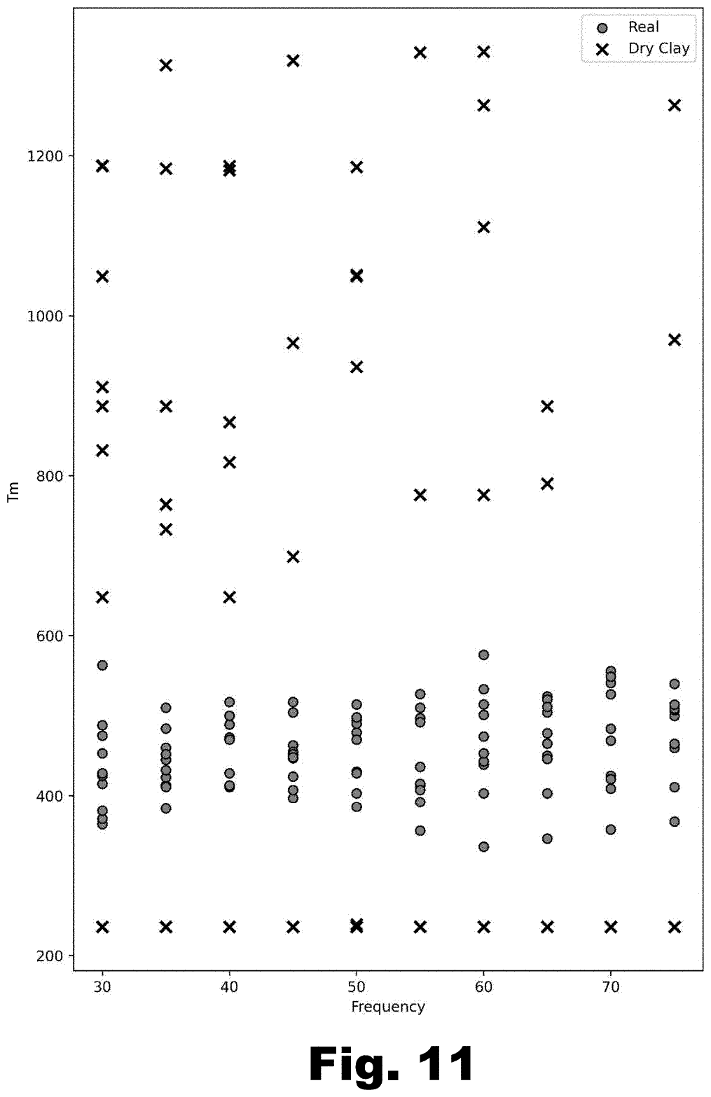

FIG. 11 is a graph showing experimental results of a state in which a fake fingerprint made of dry clay is placed between biometric authentication electrodes and a state in which the biometric fingerprint is touched. As shown in FIG. 11, it can be seen that a counterfeit fingerprint (x-marked dot) and a biometric fingerprint (circular dot) made of dry clay exhibit distinctly distinct time required Tm characteristics. It was best distinguished at the 70 Hz measurement frequency.

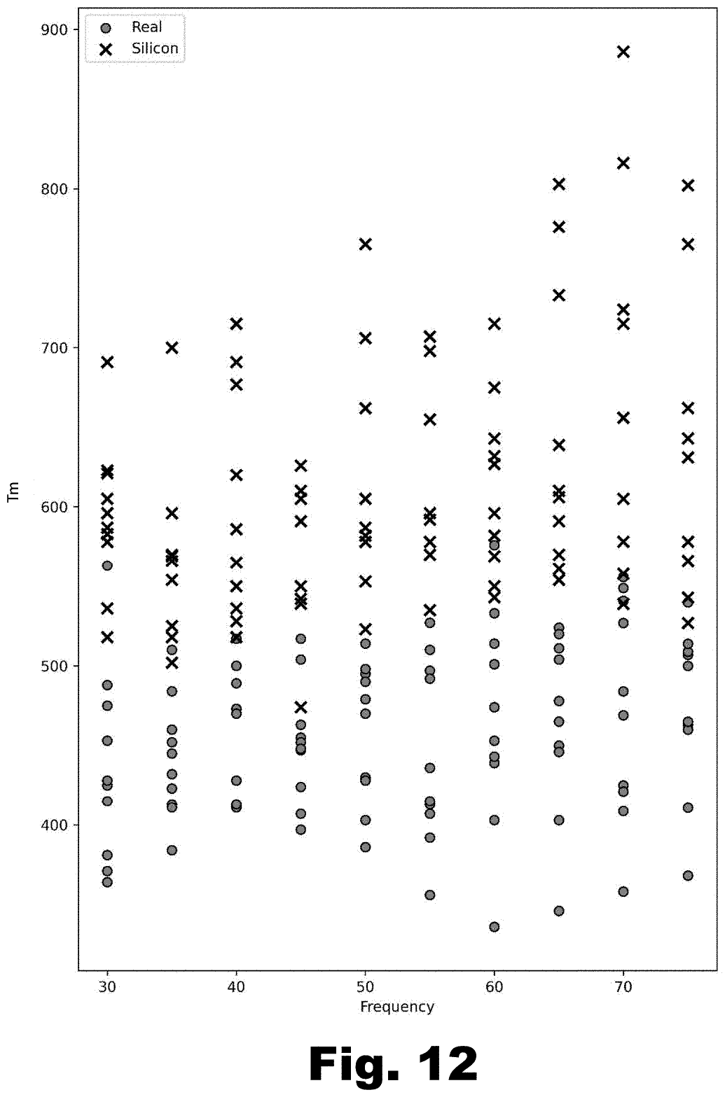

FIG. 12 is a graph showing experimental results of a state in which a fake fingerprint made of silicon is placed between the biometric authentication electrodes and a state in which the biometric fingerprint is touched. As shown in FIG. 12, it can be seen that both have a partially overlapping range. It can be seen that the silicon fingerprint (x-marked dot) shows a time required Tm of about 600 or less, whereas a biometric fingerprint (circular dot) shows a characteristic of 600 or less. It can be seen that values below 450 are distributed, while values below 450 are not distributed in the silicon fingerprint.

As can be seen from the experimental graphs shown in FIGS. 7 to 12, it can be seen that various fake fingerprints cannot be clearly distinguished from biometric fingerprints by using a single fixed frequency square wave. Therefore, it can be seen that by applying a square wave of a plurality of frequencies and measuring the required time Tm for each frequency, it is possible to distinguish between the two.

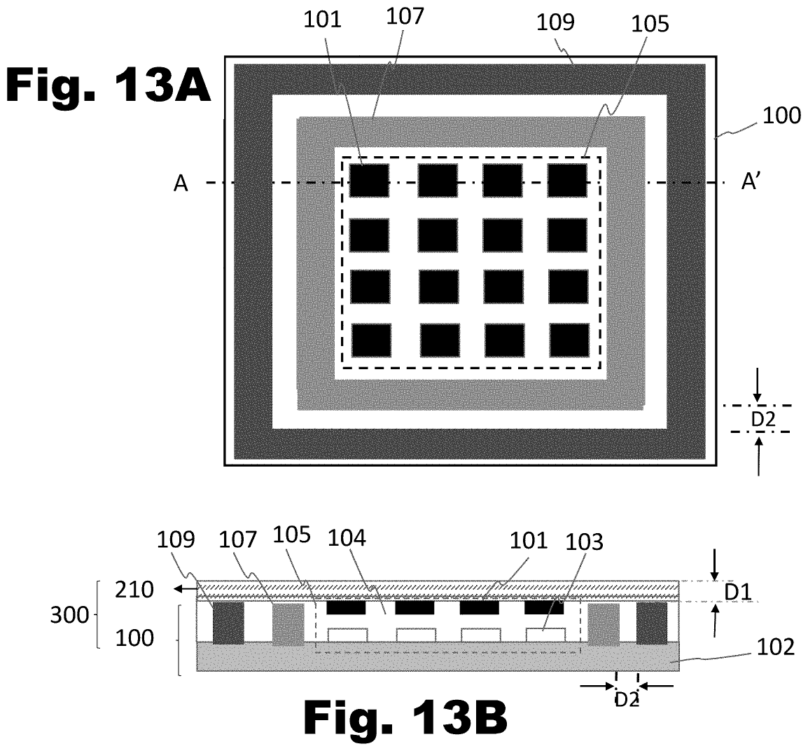

FIG. 13A is a plan view of a biometric fingerprint sensor in which an electrode for biometric recognition is formed in an annular shape and FIG. 13B is a cross-sectional view in the C-C′ direction in the plan view. In a plan view, the first electrode 107 for biometric authentication is formed along the entire outer edge of the fingerprint sensing electrode array 105, and the first electrode 107 for biometric authentication is spaced apart from the D2 interval along the entire outer edge. The second electrode 109 for biometric authentication is formed.

In the case of the electrode shape for biometric authentication shown in FIG. 2A, when the first electrode 107 for biometric authentication and the second electrode 109 for biometric authentication sufficiently contact both electrodes for biometric authentication at the narrowly facing ends, a signal capable of detecting whether a living body is present is output. On the other hand, if the center of both biometric authentication electrodes is in long contact without touching the narrow end, or when only one biometric authentication electrode is in contact, a signal of sufficient quality may not be output. On the other hand, if the electrode for biometric authentication is formed in a ring shape as shown in FIG. 13A, the first electrode 107 for biometric authentication and the second electrode 109 for biometric authentication can come into contact with each other no matter where a touch is made. Therefore, it was confirmed that a stable biometric authentication signal can be obtained.

In the above, preferred embodiments of the present invention have been described and illustrated using specific terms, but such terms are only for clearly describing the present invention, and the embodiments and described terms of the present invention are the spirit and scope of the following claims. It is obvious that various changes and changes can be made without departing from it. Such modified embodiments should not be individually understood from the spirit and scope of the present invention, but should be considered to fall within the scope of the claims of the present invention.

What is claimed is:

1. A biometric and fingerprint recognition sensor structure comprising:
a fingerprint sensing electrode array comprising a plurality of fingerprint sensing electrodes and
a biometric authentication electrodes formed to be electrically spaced apart along the outer edge of the fingerprint sensing electrode array;
wherein the biometric authentication electrodes are composed of a first electrode for biometric authentication and a second electrode for biometric authentication formed at a distance of D2 from each other, and
wherein a material having a surface resistivity (Ω/cm2) of 10¹² to 10¹³ is formed on the upper portion of the biometric authentication electrode to a height of D1.

2. The biometric and fingerprint recognition sensor structure of claim 1, wherein D2 has a value of 300 μm or less, D1 and D2 satisfy Relation 1 and the minimum value of D1 is 20 μm.
2×D1<D2<3×D1 Relation 1

3. The biometric and fingerprint recognition sensor structure of claim 2, wherein the material having a surface resistivity (Ω/cm2) of 10¹² to 10¹³ is at least one selected from an epoxy film, a polyester film, a polyimide film, and a vinyl series.

4. The biometric and fingerprint recognition sensor structure of claim 2, wherein the biometric authentication electrode is a biometric and fingerprint recognition sensor structure is formed at a position opposite to each other along the outer edge of the fingerprint sensing electrode array with a distance of D2 from each other,
the biometric authentication electrode is a biometric and fingerprint recognition sensor structure.

5. The biometric and fingerprint recognition sensor structure of claim 2, wherein the biometric authentication electrodes are comprising the first electrode for biometric authentication formed along the entire outer edge of the fingerprint sensing electrode array, and the second electrode for biometric authentication that is formed while maintaining a minimum separation distance D2 along the entire outer edge of the first electrode for biometric authentication.

6. An electronic card comprising:
a biometric and fingerprint recognition sensor structure;
a biometric and fingerprint authentication chip for authenticating whether a biometric and a fingerprint match by using the output value sensed by the biometric and fingerprint recognition sensor structure; and
an IC chip having a small capacity memory for storing important information of the holder,
wherein the biometric and fingerprint recognition sensor structure is comprised of a fingerprint sensing electrode array comprising a plurality of fingerprint sensing electrode s and a biometric authentication electrodes formed to be electrically spaced apart along the outer edge of the fingerprint sensing electrode array; and
wherein a material having a surface resistivity (Ω/cm2) of 10¹² to 10¹³ is formed on the upper portion of the biometric authentication electrode to a height of D1.

7. The electronic card of claim 6, wherein D2 has a value of 300 μm or less, the minimum value of D1 is 20 μm and D1 and D2 satisfy Relation 1.
2×D1<D2<3×D1 Relation 1

8. The electronic card of claim 7, wherein the material having a surface resistivity (Ω/cm2) of 10¹² to 10¹³ is at least one selected from an epoxy film, a polyester film, a polyimide film, and a vinyl series.

9. The electronic card of claim 8, wherein the biometric authentication electrode is a biometric and fingerprint recognition sensor structure is formed at a position opposite to each other along the outer edge of the fingerprint sensing electrode array with a distance of D2 from each other.

10. The electronic card of claim 8, wherein the biometric authentication electrodes are comprising the first electrode for biometric authentication formed along the entire outer edge of the fingerprint sensing electrode array, and the second electrode for biometric authentication that is formed while maintaining a minimum separation distance D2 along the entire outer edge of the first electrode for biometric authentication.
